(19) United States
(12) Patent Application Publication
(10) Pub. No.: US 2017/0069902 A1
(43) Pub. Date: Mar. 9, 2017

(54) SECONDARY BATTERY

(71) Applicant: SAMSUNG SDI CO., LTD., Yongin-si (KR)

(72) Inventor: Hoseong KIM, Yongin-si (KR)

(21) Appl. No.: 15/247,236

(22) Filed: Aug. 25, 2016

(30) Foreign Application Priority Data
Sep. 9, 2015 (KR) 10-2015-0127635

(51) Int. Cl. H01M 2/26; H01M 2/08; H01M 2/02

(52) U.S. Cl. CPC H01M 2/263; H01M 2/0277; H01M 2/08

(57) ABSTRACT

A secondary battery, which can reduce a product size by reducing a winding width of an electrode assembly, is provided. The secondary battery includes an electrode assembly formed by winding a first electrode plate, a second electrode plate and a separator interposed therebetween, an electrode tab welded to an uncoated portion of each of the electrode plates and upwardly protruding from the electrode assembly, an adhesion member attached to the uncoated portion and covering the electrode tab, and an insulating tape spaced apart from the electrode plates and surrounding a portion of the electrode tab upwardly protruding from the electrode assembly, wherein the electrode assembly includes a planar portion corresponding to a flatly wound region of the electrode plates and at least one round portion corresponding to a curvedly wound region of the electrode plates, and the insulating tape extends from the planar portion to the round portion.

### CROSS-REFERENCE TO RELATED APPLICATION

Korean Patent Application No. 10-2015-0127635, filed on Sep. 9, 2015, in the Korean Intellectual Property Office, and entitled: “Secondary Battery,” is incorporated by reference herein in its entirety.

### BACKGROUND

1. Field

Embodiments relate to a secondary battery.

2. Description of the Related Art

Unlike a primary battery, a secondary battery used in a battery pack can be repeatedly charged and discharged. A small-capacity secondary battery using a single battery cell packaged in the form of a pack is used for driving small portable electronic devices, such as mobile phones, camcorders, and the like, while a large-capacity secondary battery using tens of battery cells connected to each other in a battery pack may be used as power sources for driving motors such as in hybrid electric vehicles (HEV).

### SUMMARY

According to an aspect of the exemplary embodiments, there is provided a secondary battery including an electrode assembly formed by winding a first electrode plate, a second electrode plate and a separator interposed between the first electrode plate and the second electrode plate, an electrode tab welded to an uncoated portion of each of the first and second electrode plates and upwardly protruding from the electrode assembly, an adhesion member attached to the uncoated portion and covering the electrode tab, and an insulating tape spaced apart from the first and second electrode plates and surrounding a portion of the electrode tab upwardly protruding from the electrode assembly, wherein the electrode assembly includes a planar portion corresponding to a flatly wound region of each of the first and second electrode plates and at least one round portion corresponding to a curvedly wound region of each of the first and second electrode plates, and the insulating tape extends from the planar portion to the round portion.

The adhesion member may extend to a top portion of the uncoated portion and the insulating tape is adjacent to and in contact with the adhesion member.

The electrode tab and the adhesion member may be positioned on the planar portion.

A width of the planar portion may be equal to a length from the first adhesion member attached to the first electrode tab to a second adhesion member attached to a second electrode tab.

A width of the insulating tape may be larger than a width of the adhesion member.

The secondary battery may further include a pouch accommodating the electrode assembly, wherein the insulating tape is in contact with a sealing portion of the pouch.

The electrode tab may be covered by the adhesion member and the insulating tape within the pouch without being exposed to the outside, such that no gap exists between the adhesion member and the insulating tape.

According to another aspect of the exemplary embodiments, there is provided a secondary battery including an electrode assembly formed by winding a first electrode plate, a second electrode plate and a separator interposed between the first electrode plate and the second electrode plate, a first electrode tab welded to a first electrode uncoated portion of the first electrode plate and upwardly protruding from the electrode assembly, a first adhesion member attached to the first electrode uncoated portion and covering the first electrode tab, and a first insulating tape spaced apart from the first electrode plate and surrounding a portion of the first electrode tab upwardly protruding from the electrode assembly, wherein the electrode assembly includes a planar portion corresponding to a flatly wound region of each of the first and second electrode plates and at least one round portion corresponding to a curvedly wound region of each of the first and second electrode plates, and the first insulating tape extends from the planar portion to the round portion.

The secondary battery may further include a second electrode tab welded to a second electrode uncoated portion of the second electrode plate and upwardly protruding from the electrode assembly, a second adhesion member attached to the second electrode uncoated portion and covering the second electrode tab, and a second insulating tape surrounding a portion of the second electrode tab upwardly protruding from the electrode assembly, wherein the second insulating tape is attached to the second electrode uncoated portion and extends past a top portion of the second electrode uncoated portion.

The second insulating tape may be positioned on the planar portion.

### BRIEF DESCRIPTION OF THE DRAWINGS

Features will become apparent to those of ordinary skill in the art by describing in detail exemplary embodiments with reference to the attached drawings in which:

FIG. 1A illustrates an exploded perspective view of a secondary battery according to an embodiment;

FIG. 1B illustrates a perspective view of a secondary battery according to an embodiment;

FIG. 2 illustrates a perspective view of the electrode assembly of FIG. 1;

FIG. 3 illustrates a plan view depicting a state in which the electrode assembly shown in FIG. 2 is yet to be wound;

FIG. 4 illustrates a diagram for explaining a winding width of an electrode assembly;

FIG. 5A illustrates an exploded perspective view of a secondary battery according to an embodiment;

FIG. 5B illustrates a perspective view of a secondary battery according to an embodiment:

FIG. 6 illustrates a perspective view of the electrode assembly of FIG. 5;

FIG. 7 illustrates a plan view depicting a state in which the electrode assembly shown in FIG. 6 is yet to be wound; and

FIG. 8 illustrates a diagram for explaining a winding width of an electrode assembly.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

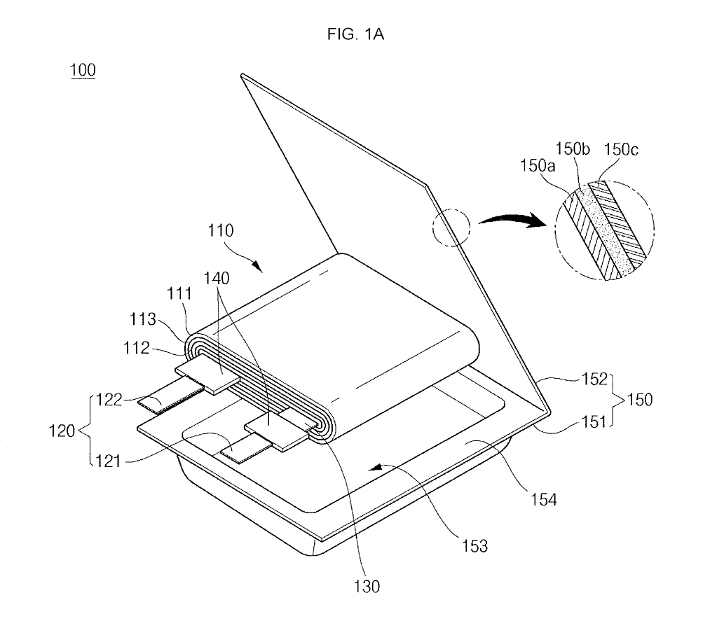

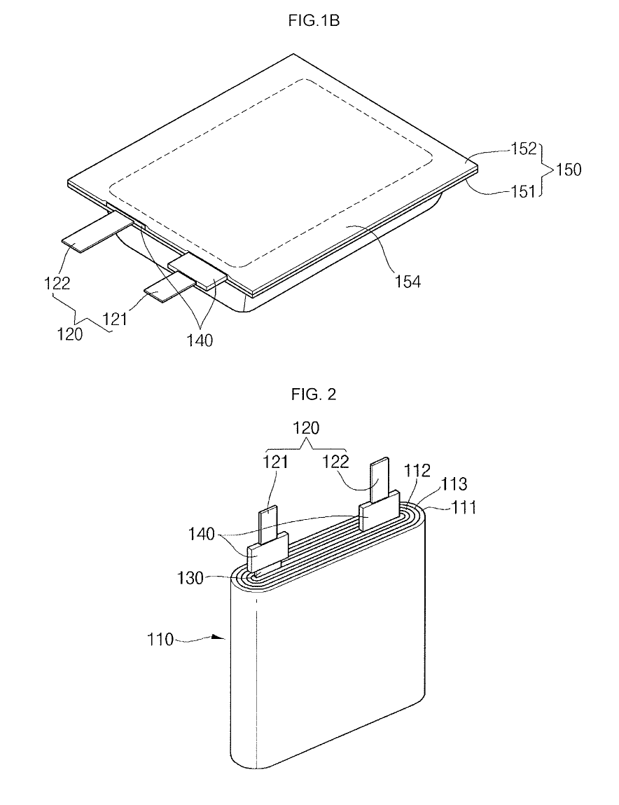

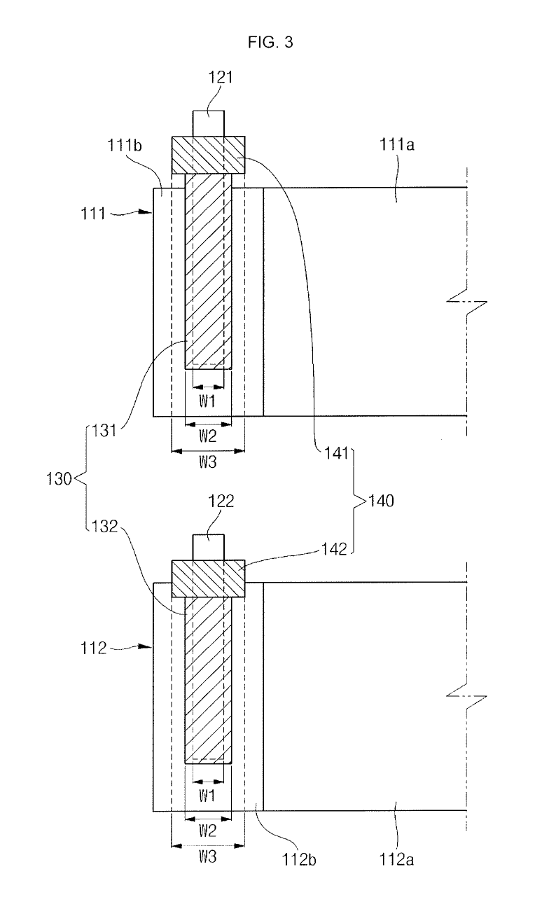

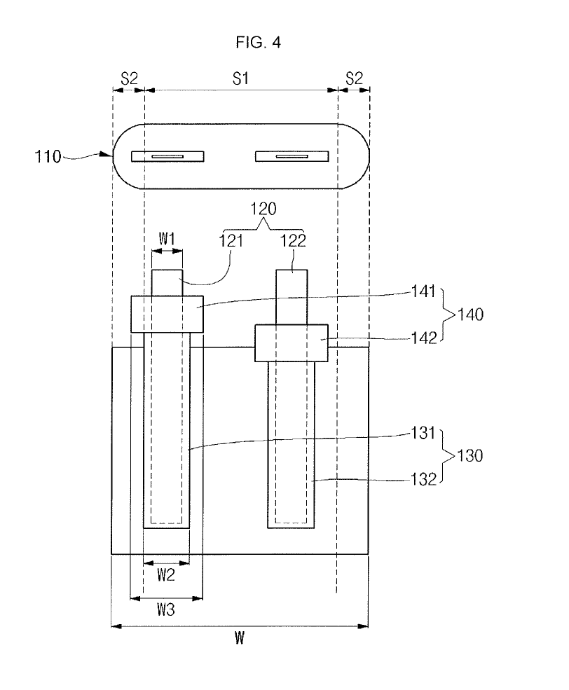

FIG. 1A illustrates an exploded perspective view of a secondary battery according to an embodiment. FIG. 1B illustrates a perspective view of a secondary battery according to an embodiment. FIG. 2 illustrates a perspective view of the electrode assembly of FIG. 1. FIG. 3 illustrates a plan view depicting a state in which the electrode assembly shown in FIG. 2 is yet to be wound. FIG. 4 illustrates a diagram for explaining a winding width of an electrode assembly.

Referring to FIGS. 1A to 4, the secondary battery 100 according to an embodiment includes an electrode assembly 110, an electrode tab 120, an adhesion member 130, an insulating tape 140 and a pouch 150.

The electrode assembly 110 includes a first electrode plate 111, a second electrode plate 112 and a separator 113 interposed therebetween. The electrode assembly 110 is formed by winding a stacked structure of the first electrode plate 111, the second electrode plate 112 and the separator 113 in a jelly-roll configuration. Here, the first electrode plate 111 may serve as a positive electrode and the second electrode plate 112 may serve as a negative electrode, for example.

The first electrode plate 111 is formed by coating a first electrode active material, such as a transition metal oxide, on a first electrode current collector made of a metal foil, such as an aluminum (Al) foil. The first electrode plate 111 includes a first electrode active material layer 111a with the first electrode active material coated thereon, and a first electrode uncoated portion 111b without the first electrode active material coated thereon. The electrode tab 120 to be described later is attached to the first electrode uncoated portion 111b.

The second electrode plate 112 is formed by coating a second electrode active material, such as graphite or carbon, on a second electrode current collector made of a metal foil, such as copper (Cu) or nickel (Ni). The second electrode plate 112 includes a second electrode active material layer 112a with the second electrode active material coated thereon, and a second electrode uncoated portion 112b without the second electrode active material coated thereon. The electrode tab 120 to be described later is attached to the second electrode uncoated portion 112b.

The separator 113 may be positioned between the first electrode plate 111 and the second electrode plate 112 to prevent a short-circuit from occurring between the first electrode plate 111 and the second electrode plate 112 and allow movement of lithium ions. In addition, the separator 113 may be formed of polyethylene (PE), polypropylene (PP) or a composite film of polyethylene (PE) and polypropylene (PP).

The electrode tab 120 is electrically connected to each of the first electrode plate 111 and the second electrode plate 112 and upwardly protrudes from the electrode assembly 110. In detail, the electrode tab 120 includes a first electrode tab 121 welded to the first electrode plate 111 and a second electrode tab 122 welded to the second electrode plate 112. One side of the first electrode tab 121 is welded to the first electrode uncoated portion 111b and the other side of the first electrode tab 121 upwardly protrudes from the electrode assembly 110. The first electrode tab 121 is made of a metal, such as aluminum (Al), and serves as a positive electrode. In addition, one side of the second electrode tab 122 is welded to the second electrode uncoated portion 112b and the other side of the second electrode tab 122 upwardly protrudes from the electrode assembly 110. The second electrode tab 122 is made of a metal, such as copper (Cu) or nickel (Ni), and serves as a negative electrode.

In addition, after being welded to the first electrode plate 111 and the second electrode plate 112, the electrode tab 120 may be tightly fixed to the first and second electrode plates 111 and 112 by the adhesion member 130. Therefore, as shown in FIG. 3, a width W2 of the adhesion member 130 is larger than a width W1 of the electrode tab 120 so as to cover the electrode tab 120. The adhesion member 130 may be made of polypropylene (PP). In addition, the adhesion member 130 includes a first adhesion member 131 attached to the first electrode tab 121 and a second adhesion member 132 attached to the second electrode tab 122.

The first adhesion member 131 covers one side of a region of the first electrode tab 121 welded to the first electrode uncoated portion 111b and is attached to the first electrode uncoated portion 111b. The first adhesion member 131 is attached to the first electrode uncoated portion 111b so as to entirely cover a region of the first electrode tab 121 welded to the first electrode uncoated portion 111b. In addition, the first adhesion member 131 upwardly protruding from the first electrode uncoated portion 111b is also attached to the region of the first electrode tab 121 upwardly protruding from the electrode assembly 110. Here, the first adhesion member 131 is also attached to an opposite side of the first electrode tab 121, so that it may upwardly protrude from the electrode assembly 110.

The second adhesion member 132 covers one side of a region of the second electrode tab 122 welded to the second electrode uncoated portion 112b and is attached to the second electrode uncoated portion 112b. The second adhesion member 132 is attached to cover the region of the second electrode tab 122 welded to the second electrode uncoated portion 112b. Here, the second adhesion member 132 is attached to the second electrode uncoated portion 112b to expose a top portion of a region of the second electrode tab 122 that is welded to the second electrode uncoated portion 112b. Therefore, the second adhesion member 132 is positioned within the second electrode uncoated portion 112b and does not entirely cover the region of the second electrode tab 122 that is welded to the second electrode uncoated portion 112b.

The insulating tape 140 is attached to the electrode tab 120 to surround the electrode tab 120. The insulating tape 140 is adjacent to the adhesion member 130 and surrounds an exposed portion of the electrode tab 120 at the top of the adhesion member 130. Here, the insulating tape 140 comes into contact with the adhesion member 130, so that there is no gap between the insulating tape 140 and the adhesion member 130. That is to say, the electrode tab 120 is not exposed at a portion between the insulating tape 140 and the adhesion member 130. The insulating tape 140 may be made of polyethyleneterephthalate (PET).

The insulating tape 140 may prevent the pouch 150 or the separator 113 from being torn by burrs generated at edges of the electrode tab 120. If the insulating tape 140 is not attached to the electrode tab 120, the pouch 150 may be torn by burrs generated at edges of the electrode tab 120 and an inner metal layer 150b of the pouch 150 that is made of aluminum (Al), for example, may be exposed. The metal layer 150b may corrode or may cause a short circuit by reacting with the second electrode tab 122 made of copper (Cu), for example. Since the first electrode tab 121 is made of the same material, i.e., aluminum (Al), as the metal layer 150b of the pouch 150, it does not cause corrosion of the pouch 150. Therefore, the second electrode tab 122 may be surrounded by the insulating tape 140 to prevent the second electrode tab 122 from being exposed within the pouch 150.

In addition, the insulating tape 140 includes a first insulating tape 141 attached to the first electrode tab 121 and a second insulating tape 142 attached to the second electrode tab 122.

The first insulating tape 141 is attached to a region of the first electrode tab 121 upwardly protruding from the first adhesion member 131. The first insulating tape 141 is attached around the first electrode tab 121 so as to surround the first electrode tab 121. A width W3 of the first insulating tape 141 is larger than a width W2 of the first adhesion member 131, as shown in FIG. 3. In addition, since the first adhesion member 131 covers a region of first electrode tab 121 upwardly protruding from the first electrode uncoated portion 111b, the first insulating tape 141 is spaced apart from the first electrode uncoated portion 111b. When the electrode assembly 110 is accommodated in the pouch 150 and the first electrode tab 121 is drawn out through the pouch 150 (see FIG. 1B), a region of the first electrode tab 121 having the first insulating tape 141 attached thereto may be brought into contact with the pouch 150. Therefore, the first insulating tape 141 may prevent a short circuit from occurring between the first electrode tab 121 and the pouch 150.

The second insulating tape 142 is attached to a region of the second electrode tab 122 upwardly protruding from the second adhesion member 132. The second insulating tape 142 is attached around the second electrode tab 122 so as to surround the second electrode tab 122. A width W3 of the second insulating tape 142 is larger than a width W2 of the second adhesion member 132, as shown in FIG. 3. In addition, since the second adhesion member 132 is attached to a top portion of the region of the second electrode tab 122 that is welded to the second electrode uncoated portion 112b, the second insulating tape 142 is positioned at least partially within the second electrode uncoated portion 112b. That is to say, the second insulating tape 142 extends from a region inside of the second electrode uncoated portion 112b past a top portion of the second electrode uncoated portion 112b. Accordingly, since any gap that may exist between the second adhesion member 132 and the second insulating tape 142 is positioned inside the wound electrode assembly 110, it is possible to prevent a short circuit from occurring between the second electrode tab 122 and the pouch 150. When the electrode assembly 110 is accommodated in the pouch 150 and the second electrode tab 122 is drawn out through the pouch 150, a region of the second electrode tab 122 having the second insulating tape 142 attached thereto may be brought into contact with the pouch 150. Therefore, the second insulating tape 142 may prevent a short circuit from occurring between the second electrode tab 122 and the pouch 150.

The pouch 150 includes a first pouch layer 151 in which the electrode assembly 110 is accommodated and a second pouch layer 152 combined with the first pouch layer 151. The pouch 150 is divided into the first pouch layer 151 and the second pouch layer 152 by folding an integrally formed rectangular pouch layer about a line about halfway along the length of the rectangular pouch layer. In addition, the first pouch layer 151 includes an accommodation groove 153 to accommodate the electrode assembly 110, which is formed by pressing, and a sealing portion 154 to be sealed with the second pouch layer 152. The first electrode tab 121 and the second electrode tab 122 are exposed to the outside of the pouch 150 through the sealing portion 154. Here, the insulating tape 140 attached to the first electrode tab 121 and the second electrode tab 122 is brought into contact with the sealing portion 154.

The pouch 150 has a multi-layered structure including a first insulation layer 150a, the metal layer 150b and a second insulation layer 150c.

The first insulation layer 150a constitutes an interior surface of the pouch 150 and is made of a material having an insulating property and a thermal adhesive property. The first insulation layer 150a may be made of a casted polypropylene (CPP) that is not reactive with an electrolyte, or any equivalent thereof If the electrode assembly 110 is accommodated in the first pouch layer 151 and is covered by the second pouch layer 152, the first insulation layers 150a of the pouch 150 are brought into contact with each other. Therefore, if the sealing portion 154 is thermally fused, the first insulation layers 150a of the pouch 150 are adhered to each other, thereby sealing the pouch 150.

The metal layer 150b is interposed between the first insulation layer 150a and the second insulation layer 150c and prevents external moisture and oxygen from penetrating into the pouch 150 and, also, prevents an electrolyte contained in the pouch 150 from flowing out. In addition, the metal layer 150b may maintain a mechanical strength of the pouch 150. The metal layer 150b may be, generally, made of aluminum (Al).

The second insulation layer 150c constitutes an exterior surface of the pouch 150 and may protect the secondary battery from a mechanical or chemical shock caused by an external electronic device. The second pouch layer 150c may be made of nylon, polyethyleneterephthalate (PET), polybutylene terephthalate (PBT), polybutylene naphthalate (PBN), or equivalents thereof.

The electrode assembly 110 may have an adjustable winding width W according to the position of the insulating tape 140. A method of adjusting the winding width W of the electrode assembly 110 will now be described with reference to FIG. 4.

The electrode assembly 110 includes a planar portion S1 corresponding to a flatly wound region of each of the first and second electrode plates 111 and 112 and a round portion S2 corresponding to a curvedly wound region of each of the first and second electrode plates 111 and 112. Here, it is assumed that a distance between the first electrode tab 121 and the second electrode tab 122 is fixed. The winding width W of the electrode assembly 110 is equal to a sum of widths of the planar portion S1 and two round portions S2. In addition, since the width of the round portion S2 is a fixed value according to the lengths of the first and second electrode plates 111 and 112, the winding width W of the electrode assembly 110 is determined by the planar portion S1. If the winding width W of the electrode assembly 110 is reduced, a width of the pouch 150 accommodating the electrode assembly 110 is also reduced, thereby ultimately reducing the size of the secondary battery 100.

The planar portion S1 is a portion where the first electrode plate 111 and the second electrode plate 112 are flatly wound, and a width of the planar portion S1 is determined according to how the first electrode tab 121 and the second electrode tab 122 are attached.

First, the first electrode tab 121 needs to be positioned within the planar portion S1, and the first adhesion member 131 attached to the first electrode tab 121 and the first electrode uncoated portion 111b also needs to be positioned within the planar portion S1. If the first adhesion member 131 is positioned on the round portion S2, the first adhesion member 131 may be separated from the first electrode uncoated portion 111b by a bending force applied to the first electrode plate 111 to create a curved portion. Since the first insulating tape 141 attached to the first electrode tab 121 is spaced apart from the first electrode uncoated portion 111b, it may not be affected by the bending force on the first electrode plate 111 even if the first insulating tape 141 extends past the planar portion S1 to the round portion S2.

Next, the second electrode tab 122 needs to be positioned within the planar portion S1, and the second adhesion member 132 attached to the second electrode tab 122 and the second electrode uncoated portion 112b also needs to be positioned within the planar portion S1. In addition, since not only the second adhesion member 132 but a portion of the second insulating tape 142 are attached to the second electrode uncoated portion 112b, the second insulating tape 142 also needs to be positioned within the planar portion S1.

As described above, the first adhesion member 131 attached to the first electrode tab 121 upwardly protrudes from the electrode assembly 110, thereby allowing the first insulating tape 141 to be spaced apart from the first electrode uncoated portion 111b. Accordingly, since the width of the planar portion S1 of the electrode assembly 110, where the first electrode plate 111 and the second electrode plate 112 are flatly wound, can be reduced, the size of the secondary battery 100 can be reduced by reducing the winding width W of the electrode assembly 110.

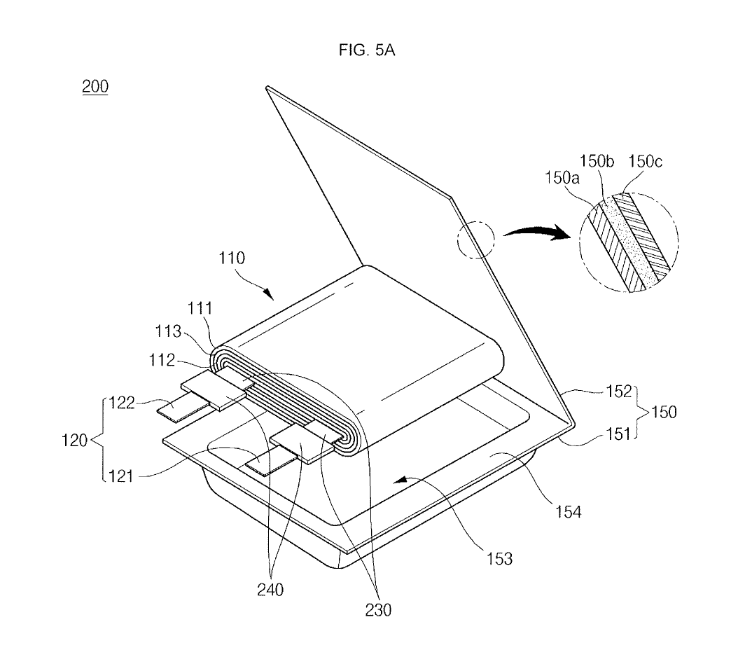

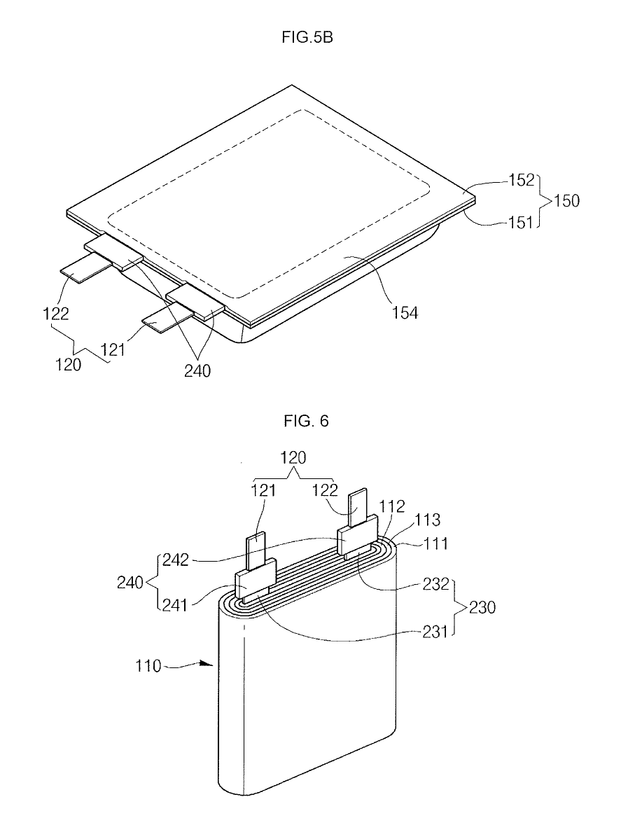

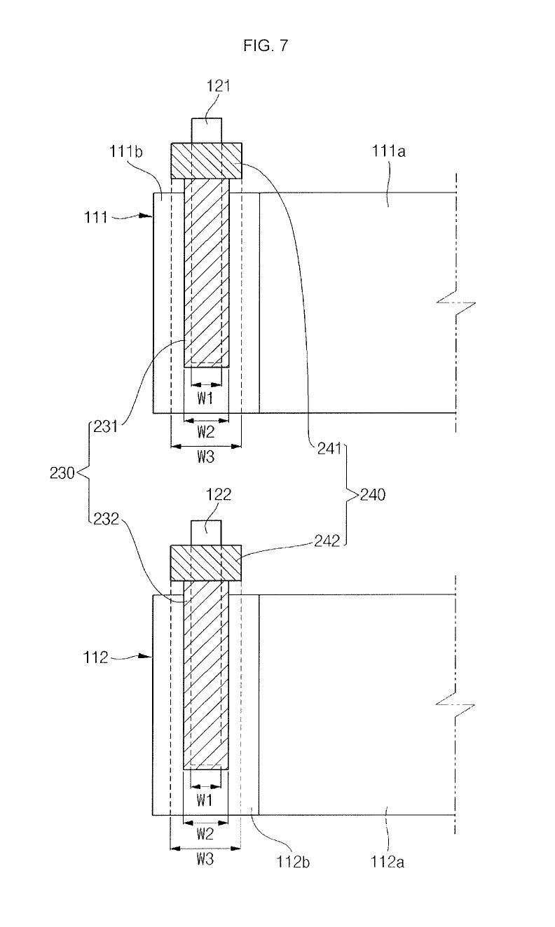

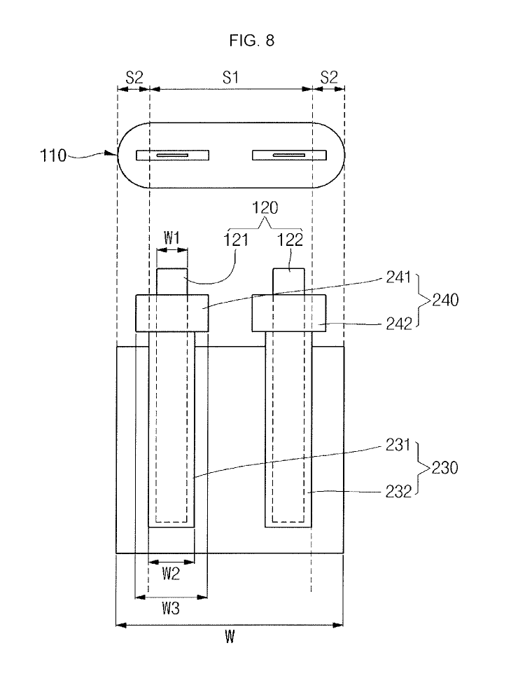

FIG. 5 illustrates a perspective view of a secondary battery according to another embodiment, FIG. 6 illustrates a perspective view of the electrode assembly of FIG. 5, FIG. 7 illustrates a plan view depicting a state in which the electrode assembly shown in FIG. 6 is yet to be wound, and FIG. 8 illustrates a diagram for explaining a winding width of an electrode assembly.

Referring to FIGS. 5 to 8, the secondary battery 200 according to another embodiment includes an electrode assembly 110, an electrode tab 120, an adhesion member 230, an insulating tape 240 and a pouch 150. The secondary battery 200 shown in FIG. 5 is substantially the same as the secondary battery 100 shown in FIG. 1, except that the adhesion member 230 and the insulating tape 240 are formed at different positions from the corresponding elements of the secondary battery 100. That is to say, a second adhesion member 232 and a second insulating tape 242 of the secondary battery 200 shown in FIG. 5 are formed at different positions from the second adhesion member 132 and the second insulating tape 142 of the secondary battery 100 shown in FIG. 1. Meanwhile, a first adhesion member 231 and a first insulating tape 241 of the secondary battery 200 shown in FIG. 5 are formed at the same positions as the first adhesion member 131 and the first insulating tape 141 of the secondary battery 100 shown in FIG. 1. The following description will focus on the differences between the secondary battery 200 shown in FIG. 5 and the secondary battery 100 shown in FIG. 1.

The adhesion member 230 includes a first adhesion member 231 attached to the first electrode tab 121 and a second adhesion member 232 attached to the second electrode tab 122. Since the first adhesion member 231 is the same as the first adhesion member 131 shown in FIG. 1, a detailed description thereof will not be repeated.

The second adhesion member 232 covers one side of a region of the second electrode tab 122 welded to a second electrode uncoated portion 112b and is attached to the second electrode uncoated portion 112b. The second adhesion member 232 is attached to cover the region of the second electrode tab 122 welded to the second electrode uncoated portion 112b. In addition, the second adhesion member 232 upwardly protrudes from the second electrode uncoated portion 112b and is also attached to a portion of the second electrode tab 122 upwardly protruding from the electrode assembly 110. Here, the second adhesion member 232 is also attached to an opposite side of the second electrode tab 122 so that it may upwardly protrude from the electrode assembly 110. Therefore, it is possible to prevent the second electrode tab 122 made of copper (Cu) from being exposed within the pouch 150, thereby preventing corrosion between the second electrode tab 122 and the pouch 150.

The insulating tape 240 includes a first insulating tape 241 attached to the first electrode tab 121 and a second insulating tape 242 attached to the second electrode tab 122. Since the first insulating tape 241 is the same as the first insulating tape 141 shown in FIG. 1, a detailed description thereof will not be repeated.

The second insulating tape 242 is attached to a region of the second electrode tab 122 upwardly protruding from the second adhesion member 232. Since the second adhesion member 232 covers a portion of the second electrode tab 122 upwardly protruding from the second electrode uncoated portion 112b, the second insulating tape 242 is spaced apart from the second electrode uncoated portion 112b. When the electrode assembly 110 is accommodated in the pouch 150 and the second electrode tab 122 is drawn out through the pouch 150 (see FIG. 5B), a region of the second electrode tab 122 having the second insulating tape 242 attached thereto may be brought into contact with the pouch 150. Therefore, the second insulating tape 242 may prevent a short circuit from occurring between the second electrode tab 122 and the pouch 150.

As described above, the first and second adhesion members 231 and 232 attached to the first electrode tab 121 and the second electrode tab 122 upwardly protrude from the electrode assembly 110, thereby allowing the first and second insulating tapes 241 and 242 to be spaced apart from the first and second electrode uncoated portions 111b and 112b. Therefore, as shown in FIG. 8, the first and second electrode tabs 121 and 122 and the first and second adhesion members 231 and 232 are only positioned on a planar portion S1. That is to say, since the first and second insulating tapes 241 and 242 are spaced apart from the first and second electrode uncoated portions 111b and 112b, the first and second insulating tapes 241 and 242 may not be affected by a bending force applied to the first and second electrode plates 111 and 112 to create a curved portion even if the first and second insulating tapes 241 and 242 extend past the planar portion S1 to the round portion S2. Therefore, a width of the planar portion S1 can be further reduced, as compared to a case where the second insulating tape 142 of the secondary battery 100 is attached to the second electrode uncoated portion 112b, shown in FIG. 4. Accordingly, the size of the secondary battery 200 can be reduced.

By way of summation and review, as electronic devices need to have reduced size and weight, small sized and light weight secondary batteries are also required. In particular, since highly reactive materials such as lithium are typically provided inside secondary batteries, reductions in size and weight of such secondary batteries are constrained for safety reasons. Accordingly, it is necessary to develop a structure which can be small in size and light in weight while having good safety characteristics.

Embodiments are directed to a secondary battery, which can reduce a product size by reducing a winding width of an electrode assembly. As described above, in the secondary battery according to an exemplary embodiment, an adhesion member attached to electrode tabs is made to upwardly extend from an electrode assembly, so that an insulating tape surrounding electrode tabs on the adhesion member may be spaced apart from electrode uncoated portions. Accordingly, since a width of a planar portion of an electrode plate, which is flatly wound in the electrode assembly, is reduced, a winding width of the electrode assembly is reduced. thereby reducing the size of the secondary battery.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery comprising:
an electrode assembly formed by winding a first electrode plate, a second electrode plate and a separator interposed between the first electrode plate and the second electrode plate;
an electrode tab welded to an uncoated portion of each of the first and second electrode plates and upwardly protruding from the electrode assembly;
an adhesion member attached to the uncoated portion and covering the electrode tab; and
an insulating tape spaced apart from the first and second electrode plates and surrounding a portion of the electrode tab upwardly protruding from the electrode assembly,
wherein the electrode assembly includes a planar portion corresponding to a flatly wound region of each of the first and second electrode plates and at least one round portion corresponding to a curvedly wound region of each of the first and second electrode plates, and the insulating tape extends from the planar portion to the round portion.

2. The secondary battery as claimed in claim 1, wherein the adhesion member extends to a top portion of the uncoated portion and the insulating tape is adjacent to and in contact with the adhesion member.

3. The secondary battery as claimed in claim 1, wherein the electrode tab and the adhesion member are positioned on the planar portion.

4. The secondary battery as claimed in claim 1, wherein the electrode tab includes a first electrode tab and a second electrode tab, the adhesion member includes a first adhesion member and a second adhesion member, and a width of the planar portion is equal to a length from the first adhesion member attached to the first electrode tab to the second adhesion member attached to the second electrode tab.

5. The secondary battery as claimed in claim 1, wherein a width of the insulating tape is larger than a width of the adhesion member.

6. The secondary battery as claimed in claim 1, further comprising a pouch accommodating the electrode assembly, wherein the insulating tape is in contact with a sealing portion of the pouch.

7. The secondary battery as claimed in claim 1, wherein the electrode tab is covered by the adhesion member and the insulating tape within a pouch such that no gap exists between the adhesion member and the insulating tape.

8. A secondary battery comprising:
an electrode assembly formed by winding a first electrode plate, a second electrode plate and a separator interposed between the first electrode plate and the second electrode plate;
a first electrode tab welded to a first electrode uncoated portion of the first electrode plate and upwardly protruding from the electrode assembly;
a first adhesion member attached to the first electrode uncoated portion and covering the first electrode tab; and
a first insulating tape spaced apart from the first electrode plate and surrounding a portion of the first electrode tab upwardly protruding from the electrode assembly,
wherein the electrode assembly includes a planar portion corresponding to a flatly wound region of each of the first and second electrode plates and at least one round portion corresponding to a curvedly wound region of each of the first and second electrode plates, and the first insulating tape extends from the planar portion to the round portion.

9. The secondary battery as claimed in claim 8, further comprising:
a second electrode tab welded to a second electrode uncoated portion of the second electrode plate and upwardly protruding from the electrode assembly;
a second adhesion member attached to the second electrode uncoated portion and covering the second electrode tab; and
a second insulating tape surrounding a portion of the second electrode tab upwardly protruding from the electrode assembly,
wherein the second insulating tape is attached to the second electrode uncoated portion and extends past a top portion of the second electrode uncoated portion.

10. The secondary battery as claimed in claim 9, wherein the second insulating tape is positioned on the planar portion.
